(19) United States
(12) Patent Application Publication
(10) Pub. No.: US 2023/0169505 A1
(43) Pub. Date: Jun. 1, 2023

(54) SYSTEM AND TECHNIQUES FOR AUTHENTICATED WEBSITE BASED CHECKOUT USING UNIFORM RESOURCE LOCATOR

(71) Applicant: Capital One Services, LLC, McLean, VA (US)

(72) Inventors: Jeffrey RULE, Chevy Chase, MD (US); Kevin OSBORN, Newton, MA (US)

(73) Assignee: Capital One Services, LLC, McLean, VA (US)

(21) Appl. No.: 17/538,351

(22) Filed: Nov. 30, 2021

(51) Int. Cl. G06Q 20/40; G06Q 20/34; G06Q 20/38

(52) U.S. Cl. CPC G06Q 20/4012; G06Q 20/352; G06Q 20/382

(57) ABSTRACT

Disclosed are a system, computer readable medium and a method in which a notification is received from a website that an authentication request will be received at the financial institution system within a predetermined time period. A prompt that includes a request for confirmation of a pending transaction via a near-field communication interaction with a contactless card, is presented on a mobile device that corresponds to the verification identifier of the user. In response to a near-field communication interaction responsive the prompt, an encrypted authentication payload may be received at an authentication web address as confirmation of the pending transaction. The payload is decrypted, and parameters obtained from the decrypted authentication payload. The user may be authenticated as a holder of the contactless card using one or more of the parameters. In response, the pending transaction is completed by sending user identifying information to the website.

### BACKGROUND

During customer present transactions, such as those a brick and mortar locations, a customer may present a chip-enabled credit card to a chip reader, or a contactless credit card in a “tap” exchange, each of which provide encrypted information that is accepted as authenticating the customer as the person associated with the credit card account.

In contrast, online transactions typically do not afford the opportunity for users to provide the encrypted information obtained from the chip-enabled card reader or the “tap” exchange of a contactless reader to the merchant. During the online transaction, the merchant may presume, or has to presume, that the information, such as an account number or address, provided by the consumer is authenticatable by the financial institution and therefore, may not vigorously vet the information provided by the consumer.

In addition, if the consumer is the target of identity theft, the consumer has no protection against the fraudulent transaction either because they may not have any idea the fraud is occurring until receipt of the account statement.

It would be advantageous if the consumer and the online merchant were confident that the transaction between them was secure and, for the merchant, that the identity of the consumer was authenticable so as to reduce fraud and improve the security of the online transaction.

### BRIEF SUMMARY

In one aspect, a method is provided that includes a step of receiving, at a financial institution system from a website, a notification that a financial transaction authentication request from a user will be received at the financial institution system within a predetermined time period of receipt of the notification. The notification includes a verification identifier of a user that was input during a transaction session with the website. A prompt may be generated for presentation on a mobile device corresponding to the verification identifier of the user. The presented prompt may include a request for confirmation of a pending transaction via a near-field communication interaction with a contactless card associated with the financial institution. In response to a near-field communication interaction responsive to presentation of the presented prompt, a financial transaction authentication request including an encrypted authentication payload may be received at an authentication web address of the financial institution system as confirmation of the pending transaction. A portion of the encrypted authentication payload is maintained on the contactless card. The encrypted authentication payload may be decrypted, and multiple parameters may be obtained from the decrypted authentication payload. The user may be authenticated as a holder of the contactless card using one or more of the multiple parameters. In response to authenticating the user as a holder of the contactless card, completion of the pending transaction may be enabled by sending user identifying information to the website.

In another aspect, a non-transitory computer-readable storage medium is provided. The computer-readable storage medium includes instructions that when executed by a computer, cause the computer, at a financial institution system to receive from a website a notification that an authentication request from a user will be received at the financial institution system within a predetermined time period of receipt of the notification. The notification includes a verification identifier of a user that was input during a transaction session with the website. The instructions may cause the computer to have a prompt presented on a mobile device corresponding to the verification identifier of the user. The presented prompt may include a request for confirmation of a pending transaction via a near-field communication interaction with a contactless card associated with the user and the financial institution. In response to a near-field communication interaction responsive to presentation of the presented prompt, a financial transaction authentication request including an encrypted authentication payload may be received at an authentication web address of the financial institution system as confirmation of the pending transaction. A portion of the encrypted authentication payload is maintained on the contactless card. The encrypted authentication payload may be decrypted to obtain multiple parameters from the decrypted authentication payload. The user may be authenticated as a holder of the contactless card using one or more of the multiple parameters. Completion of the pending transaction may be enabled by sending user identifying information to the website in response to authenticating the user as a holder of the contactless card.

In one aspect, a computing apparatus includes a processor circuit and a memory. The memory stores instructions that, when executed by the processor, the computing apparatus is operable to receive a notification that an authentication request from a user will be received within a predetermined time period of receipt of the notification. The notification includes a verification identifier of a user that was input during a transaction session with the website. The computing apparatus may cause a prompt to be presented on a mobile device corresponding to the verification identifier of the user. The presented prompt includes a request for confirmation of a pending transaction via a near-field communication interaction with a contactless card associated with the financial institution. In response to a near-field communication interaction responsive to presentation of the prompt, a financial transaction authentication request including an encrypted authentication payload may be received at an authentication web address of the financial institution system as confirmation of the pending transaction. A portion of the encrypted authentication payload is maintained on the contactless card. The encrypted authentication payload may be decrypted, and multiple parameters may be obtained from the decrypted authentication payload. The user may be authenticated as a holder of the contactless card using one or more of the multiple parameters. In response to authenticating the user as a holder of the contactless card, completion of the pending transaction may be enabled by sending user identifying information to the website.

### BRIEF DESCRIPTION OF THE DRAWINGS

Reference is now made to the drawings, wherein like reference numerals are used to refer to like elements throughout.

FIG. 1 illustrates an example of a system implementation of the disclosed subject matter.

FIG. 2 illustrates an example process in accordance with an embodiment of the disclosed subject matter.

FIG. 3 illustrates a functional block diagram of a system suitable for implementing the described techniques of the disclosed subject matter.

FIG. 4 illustrates an example of a contactless card usable in the examples described herein.

FIG. 5 illustrates additional features of the example contactless card of FIG. 4.

FIG. 6 illustrates an example of a computing architecture suitable for implementing the examples of FIGS. 1-5.

FIG. 7 illustrates an example of a mobile device usable for implementing the techniques and processes discussed with reference to the examples of FIGS. 1-5.

### DETAILED DESCRIPTION

With general reference to notations and nomenclature used herein, one or more portions of the detailed description which follows may be presented in terms of program procedures executed on a computer or network of computers. These procedural descriptions and representations are used by those skilled in the art to convey the substances of their work most effectively to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

The following provides a description of an improved transaction system and techniques that enable an online merchant and a consumer to have with a high degree of certainty that the person or, in the case of a business, the entity that the consumer is asserting to be is actually that person or entity.

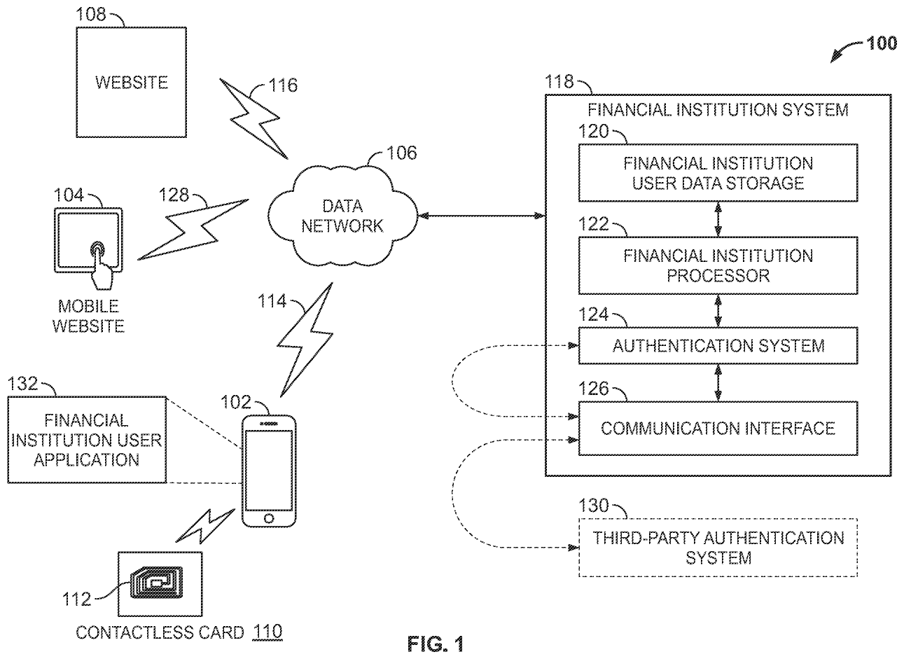

FIG. 1 illustrates an example of a system implementation of the disclosed subject matter. The system 100 may include a financial institution system 118, website 108, a mobile website 104, a mobile device 102, a contactless card 110 and a data network 106.

The data network 106 may be a network, such as the internet, a wide area network, a local area network, a metropolitan area network, a cellular network, a combination of networks, or the like, that enables different devices and systems communicate with one another.

The website 108 and the mobile website 104 may be services executing on servers or cloud platforms that provide services or products from service providers or merchants

The financial institution system 118 may be provided by an entity, such as a bank, mortgage company, investment firm, credit card issuer or the like, and the entity be referred to herein after as a “financial institution.” The financial institution may have business relationships with a number of merchants. The number of merchants may include merchants that conduct business through online businesses, that sell merchandise and/or services through online transactions made possible by websites, such as website 108 and mobile website 104. In addition, or alternatively, the financial institution may have business relationships with a number of consumers that interact with the financial institution system 118 via their mobile devices, such as mobile device 102. As part of the relationship with the consumer, the financial institution may provide the consumer after a sufficient amount of vetting (to confirm identity, physical address, income, household members, account information and the like) with a contactless card 110.

The contactless card 110 as described in later examples may be operable to provide encrypted authentication information that is authenticatable by the financial institution system 118. The contactless card 110 may be equipped with a near-field communication (NFC) device 112. The NFC device 112 may be operable to communicate with an NFC device (not shown in this example) in the mobile device 102.

The mobile device 102 may be operable to communicate with the financial institution system 118 via a communication link 114. The mobile device 102 may be operable to provide information obtained from the contactless card 110 to the financial institution system 118 via an instance of the user application 132. The user application 132 may be an application that facilitates obtaining the encrypted authentication information from the contactless card 110.

The financial institution system 118 may include a number of systems, memories, modules and components, such as a user data storage 120, a financial institution processor 122, an authentication system 124 and a communication interface 126.

The communication interface 126 may be operable to facilitate communication by the financial institution system 118 with the mobile device 102, the mobile website 104, and/or website 108 via the data network 106. The communication link 128 may couple the mobile website 104 to the data network 106. Similarly, the communication interface 126 may be operable to receive information from each of the mobile device 102, the mobile website 104 and the website 108 sent through the data network 106. The communication interface 126 may communicate via the data network 106 using known communication protocols.

The user data storage 120 may securely maintain information regarding the user that is used by the authentication system 124 to authenticate the user. For example, the maintained information regarding the user may include personal identifying information (PII), such as the user's name, home address, spousal information, telephone numbers, bank loan balances, types of accounts, types of automobiles secured by loans (e.g., Chevrolet® Tahoe®), mobile phone identifier (e.g., International Mobile Equipment Identity (IMEI) number or the like), passwords, permanent account numbers, past virtual account numbers, a transaction count and the like.

The financial institution processor 122 may be operable to receive the encrypted information, which may also be referred to as an encrypted authentication payload of the contactless card 110, from the communication interface 126. The financial institution processor 122 may be operable to process the encrypted information and forward encrypted authentication information to the authentication system 124.

The authentication system 124 may be a component (e.g., a processor, software, a combination of both) that decrypts (if needed) and/or authenticates information provided by a user, such as an identifier provided by the user to the website 108, authentication information from the contactless card 110, and the like. For example, the authentication system 124 may be a component that utilizes decryption algorithms to decrypt the encrypted authentication information and evaluate the decrypted to authentication information to user information obtained from the user data storage 120. Optionally, the authentication system 124 may interface with a third-party authentication system 130, which may provide some or all of the same functionality of the authentication system 124.

Customer enters an identifier into a field of a web page presented by the web browser (such as a phone identifier, an email address, a permanent account number (PAN), or the like). The user may enter the first 5 digits of the PAN, which provides the mobile website 104 with enough information to identify the user's financial institution. The identifier may include other additional information, such as a special keyword, an account number or name maintained in relation to the website 108 or mobile website 104, or the like that indicates to the website 108 and or mobile website 104. Alternatively, the user may select a financial institution presented on the web page of the website 108 and or mobile website 104 for use in the authentication process.

The website 108 may be operable to identify the user as a user in a centralized database or bank identification number. In a detailed example, the website 108 may have relationships with a number of different financial institutions. When the website 108 receives a user's identifying information, such as the phone identifier or email address, the website 108 may broadcast that information to all of the number of different financial institutions with which the website 108 has relationships. The first financial institution that responds with a confirmation is the one with which the website 108 will continue to conduct the transaction session with the first responding financial institution. The mobile website 104 may be operable to be presented and operate on mobile devices, such as a smartphone, laptop, tablet device or the like, and to function in a similar manner as the website 108.

The foregoing system 100 may be operable to provide the secure authentication of the user and streamlined secure transactions as outlined in the following process examples.

Customer may be asked to tap a contactless card to phone for a background read of authentication information usable by the financial institution to authenticate the user. In some examples, the present disclosure refers to a “tap” of the contactless card. However, it is understood that the present disclosure is not limited to a tap, and that the present disclosure includes other gestures (e.g., a wave or other movement of the card). The authentication information read by the phone may be a uniform resource locator (URL) associated with the financial institution. The URL may contain an encrypted payload which is authenticated by an authentication system 124 of the financial institution system 118. Alternatively, the authentication of the user may also serve as an approval of the transaction, in which case, any account information or the like needed by the merchant to complete the transaction at the website 108 may be provided by the financial institution and a notification that the transaction is completed may be presented by the user.

Financial institution sends authentication response to merchant along with rest of personal identifiable information (PII) data and possibly a virtual card number (VCN), which may be a 15- or 16-digit number like a credit card number but without the physical credit card being present.

Essentially, the user merely provides their identifier (email address or telephone number) and taps a contactless card 110 to the mobile device 102, and upon authentication, the information (e.g., PII data, most frequent shipping address, and the like) for completing the transaction may be provided to the merchant.

The request to tap card to phone may cause the launch of a web browser on either a portable device presenting the mobile website 104 or a computing device that presents the website 108. For example, the financial institution may also generate a request to tap alert (e.g., a prompt) on their phone via an in-app notification or via SMS to initiate an authentication process as discussed herein. When the website 108 generates a browsing session for the user transaction, the browsing session is assigned a browsing session identifier. Information input during the browsing session, such as user's name, the shipping address, product identifiers that identify products to be purchased, and the like are saved with reference to the browsing session identifier. The browsing session identifier allows the merchant to quickly reconvene the user's shopping experience. A link containing the browsing session identifier may be provided with the authentication request to the financial institution. Upon authentication by the financial institution system, the user may resume the commerce session at the website 108 or mobile website 104. For example, the authentication result may be delivered by the authentication system 124 or the like of the financial institution system 118 and may include the browsing session identifier and information regarding the user. The browsing session may be a secure or encrypted communication link. The information regarding the user provided by the authentication system 124 may include the user's name, user's shipping address, user's contact information, and the like.

In an example, the encrypted authentication payload is sent in URL to financial institution backend, which is expecting the payload in a message for authentication. Encrypted authentication payload may include version number (if multiple versions), unique identifier of person, application transaction counter, one-time password, and a cryptogram that is used to validate message integrity. For example, a URL message may be structured as “www.financialinstitutionname.com/fintech1?AUTHENTICATION MESSAGE” or the like. Upon receipt of the URL message, the OS of the mobile device may be operable to contact the financial institution at the URL and provide the AUTHENTICATION MESSAGE to the financial institution system 118. The financial institution system 118 associated with the URL may be operable to take the AUTHENTICATION MESSAGE and authenticate the user, determine if there is a pending transaction (for example, based on the earlier notification from the website 108) and provide the needed information to complete the transaction. Alternatively, the URL message may be processed by the OS of the mobile device to be sent as a text message to the financial institution system, which may be operable to access the URL in the message. The information usable to complete the transaction may be provided in an authentication response to merchant that includes some additional PII data (that may not have already been input to the website 108 by the user) and possibly a virtual card number (VCN).

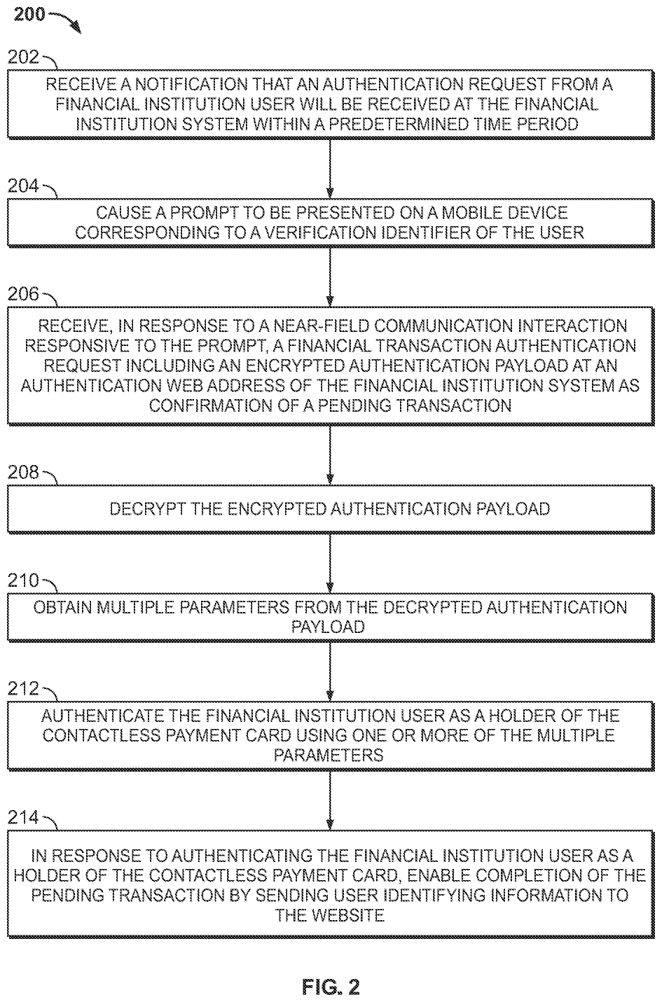

FIG. 2 illustrates an example process in accordance with an embodiment of the disclosed subject matter. The process 200 may be performed by different components of the system 100 as described above.

With reference to FIG. 2, in block 202 of process 200, the financial institution system may receive from a website, a notification (or alert) that an authentication request from a user, such as a user associated with the mobile device 102 of FIG. 1, will be received at the financial institution system within a predetermined time period of receipt of the notification. The notification may include a verification identifier of a user (e.g., a name, username, email address, cellular phone number, or the like) that was input during a transaction session with the website. For example, while inputting information into the website during the transaction session, the user may input, in addition to their verification identifier, payment card information or an indication of a financial institution that will facilitate payment for the transaction. Based on that payment card or financial institution information, the website may, for example, be operable to send a notification message to the financial institution that alerts the financial institution to expect a financial transaction authentication request within a predetermined time window or after a time out period. The predetermined time window or time out period during which the financial institution may expect to receive the financial transaction authentication request may be, for example, 30 seconds, 15 seconds, 20 seconds, 1 minute, a range such as 30-45 seconds, or the like, from when the notification is received.

In block 204, the financial institution system 118 when executing the process 200 may cause a prompt to be presented on a mobile device corresponding to the verification identifier of the user. Referring back to FIG. 1, for example, the user application 132 executing on the mobile device 102 may be in communication with the financial institution system 118. Upon receipt of wherein the prompt includes a request for confirmation via a near-field communication interaction with a contactless card associated with the financial institution. In more detail, a signal from the financial institution system 118 may populate a message with instructions executable by the mobile device that cause the mobile device to initiate a background near-field communication read of a contactless card associated with the user. The message may be forwarded to the mobile device and in response the mobile device is operable to cause presentation of the prompt and initiation of the background read by a near-field communication device of the mobile device of the contactless card. For example, the forwarded message may include instructions to the mobile device that cause the mobile device to present the prompt and to initiate a background read of the contactless card by a near-field communication device of the mobile device. Alternatively, or selectively based on a user preference, the user may interact with the prompt to cause the initiation of the background read of the contactless card. In some examples, the message with the instructions may include a hyperlink to the authentication web address of the financial institution. The financial institution system 118 may forward the message to the mobile device corresponding to the verification identifier of the user. In some examples, the message may be formatted as a short message service message, a multimedia messaging service message, or as a financial institution in-application notification. The operating system of the mobile device may be operable to receive the message regardless of the format and execute the instructions.

In an example, the financial institution system 118 may after expiration of the predetermined time period, receive a hyperlink/URL corresponding to the transaction session from the website 108 or mobile website 104. The transaction session may have been deactivated by the website after the expiration of the predetermined time period. The hyperlink/URL corresponding to the transaction session may include data that enables the transaction session to be reactivated by the website 108 or mobile website 104 without loss of the information (e.g., shopping cart information, customer information or the like) that has already been entered. The financial institution system 118 may temporarily maintain the hyperlink/URL in a data storage in association with information related to the user (e.g., user data storage 120).

In block 206, process 200 receives, in response to a near-field communication interaction responsive to presentation of the prompt, an encrypted authentication payload at an authentication web address of the financial institution system. The authentication web address may be a URL provided as part of the message obtained from the contactless card during the near-field communication interaction. In the example, there may be two URLs: an authentication URL having the web address that is provided by the contactless card, and a transaction session URL. In some examples, a portion of the encrypted authentication payload is maintained on the contactless card.

The user application 132 executing on the mobile device 102 may be in communication with the financial institution system 118. The mobile device 102 in response to instructions from the user application 132 and may forward an encrypted financial transaction authentication request to the financial institution system 118 for authentication.

The financial transaction authentication request may include one or more uniform resource locators (URL). A first URL may be generated by the website 108 and may be a URL that enables the user to resume the checkout flow if the user leaves the commercial website (as may be the case when the financial transaction authentication request is sent).

In block 208, as process 200 continues within the financial institution system 118, the financial transaction authentication request may be received and forwarded to the authentication system 124. The authentication system 124 may be operable to decrypt the encrypted authentication payload. For example, the 124 may be operable to apply a decryption algorithm to decrypt the encrypted authentication payload.

In block 210, the process 200 obtains multiple parameters from the decrypted authentication payload. The multiple parameters in the encrypted authentication payload include, for example, a version number, a unique identifier of the user, an application transaction counter, a one-time password, or a cryptogram usable to validate message integrity. A version number may be needed to select different decryption algorithms or the like as versions of the information or protocols are updated and legacy contactless cards remain in use. The other parameters are described and explained in more detail with reference to later examples.

In block 212, the authentication system 124 may authenticate the user as a holder of the contactless card using one or more of the multiple parameters. For example, the process 200 may use one or more of the multiple parameters to confirm that information related to the user provided by the website is substantially identical to information of the user maintained by the financial institution system 118.

In block 214, process 200, in response to authenticating the user as a holder of the contactless card, the financial institution system 118 enables completion of the transaction by sending user identifying information to the website 108 or mobile website 104. For example, the financial institution system 118 may send with the user identifying information the transmission session hyperlink/URL to the website 108 or mobile website 104 so the transaction session may be reactivated at the website.

In addition, when the authentication result confirms the user information matches the encrypted authentication information, the website 108 or the mobile website 104 may be provided with the shipping address and contact information that the financial institution system has on-file for the user to further thwart fraudulent activity through the website 108 or the mobile website 104. For example, the financial institution has a high degree of confidence that the shipping address is correct as the financial institution sent the contactless card to that address.

When the authentication result does not indicate a match between the information provided by the user to the commence website 108 and the encrypted authentication information, the authentication system 124 or third-party authentication system 130 may provide an indication that the pending transaction may be fraudulent and that either the transaction should be canceled or that further information is required or the like.

The examples disclosed herein provide secure techniques to use a contactless card in the authentication of a user for completion of a transaction with a website. Generally, the near-field communication settings of the computing device may be operable to perform background reads (e.g., the operating system of the computing device causes the performance of the near-field communication read) of near-field communication devices within communications range of the near-field communication circuitry of the computing device. For example, a contactless card having a near-field communication device may come within communications range of a computing device, e.g., via a tap gesture, and in response, the contactless card may generate a uniform resource locator (URL) that may be transmitted in a message to the computing device.

At least a portion of the URL may be directed to an application server hosting one or more applications and/or application segments. The applications or application segments may include applications available via application stores, while the segments of the applications may include a portion the application (e.g., one or more pages, one or more functions, etc.). For example, the application segments may be on-demand applications, such as instant applications and/or progressive web applications. One or more application segments associated with the URL may be downloaded to and executed on the computing device.

The URL generated by the contactless card may further include data used by an authentication server as part of a validation process. For example, the URL may include encrypted data that is decrypted by the server as part of the validation process. The downloaded application segments may receive the URL and extract the encrypted data. The downloaded application may then transmit the encrypted data to the authentication server for authentication and validation. Once validated, the authentication server may return an authentication result to the user application 132. The authentication result may include a confirmation that the encrypted authentication information matched the information that the user provided to the website 108.

Advantageously, embodiments disclosed herein improve the integrity and the speed of executing the authentication and completion of transactions between merchants and user devices. For example, embodiments disclosed herein provide the authentication of a user when attempting to complete an on-line purchase with a merchant.

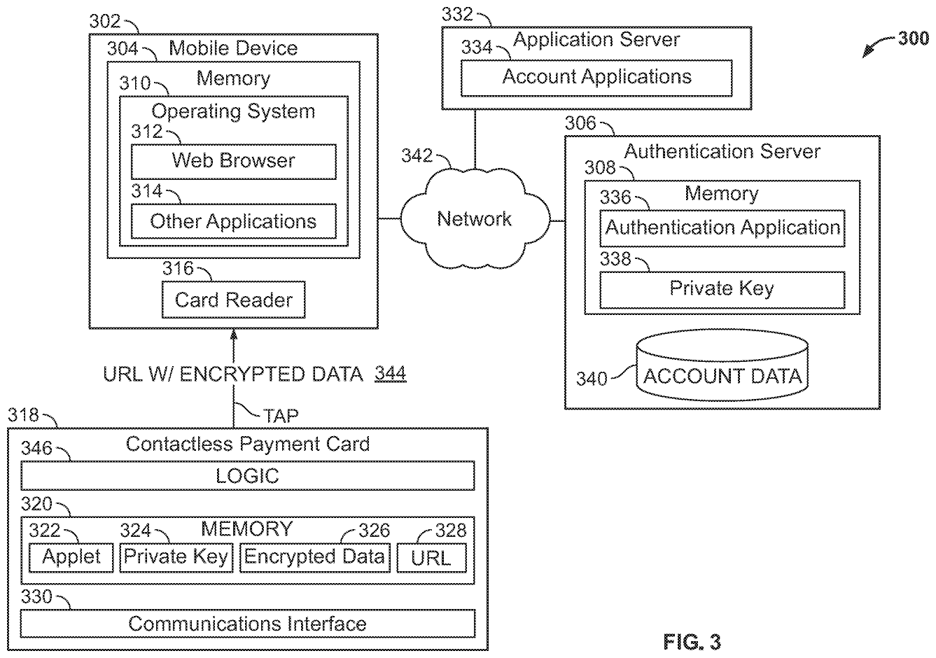

FIG. 3 illustrates a functional block diagram of a system suitable for interacting with a website utilizing the described techniques of the disclosed subject matter. As shown, the system 300 includes one or more contactless payment card 318, a mobile device 302, an authentication server 308, and an application server 332. The application server 332 may have account application 334 that may be responsive to inquiries from the authentication application 336 that enables the authentication application 336 to authenticate the user as discussed in earlier examples. The contactless payment card 318 is representative of any type of payment cards, such as a credit card, debit card, ATM card, gift card, and the like. The contactless payment card 318 may comprise one or more chips (not depicted in this example), such as a radio frequency identification (RFID) chip, configured to communicate with the mobile device 302 via NFC, the EMV standard, or other short-range protocols in wireless communication. For example, the contactless payment card 318 includes logic 346, a memory 320, and a communications interface 330. The memory 320 may include an applet 322, a private key 324, encrypted data 326 and URL 328. Although NFC is used as an example communications protocol, the disclosure is equally applicable to other types of wireless communications, such as the EMV standard, Bluetooth, and/or Wi-Fi. The mobile devices contactless card 110 are representative of any type of network-enabled computing devices, such as smartphones, tablet computers, wearable devices, laptops, portable gaming devices, and the like. The servers are representative of any type of computing device, such as a server, workstation, compute cluster, cloud computing platform, virtualized computing system, and the like.

As shown, a memory 304 of the mobile device 302 includes an instance of an operating system (OS). Example operating systems include the Android® OS, iOS®, macOS®, Linux®, and Windows® operating systems.

As another example, a user may make purchases from a merchant's website using the website 115 and/or the other application 116 provided by the merchant. To complete the transaction, the user may provide card data to one or more forms in the web browser 312 and/or the other applications 314.

Generally, when conducting an on-line transaction, after entering their name and address (either manually or via an autofill function) the user manually enters their card number, expiration date and/or CVV. Some mobile operating systems allow such data to be autofilled into forms, but other mobile operating systems impose restrictions on autofilling such data. Furthermore, in operating systems that allow the data to be autofilled in forms, the user must be authenticated through a dedicated application to do so. Advantageously, however, the examples disclosed herein solve such issues by leveraging the contactless payment card 318 to authenticate the user.

To do so, a user may tap the contactless payment card 318 to the mobile device 302, thereby bringing the contactless payment card 318 sufficiently close to the card reader 316 of the mobile device 302 to enable NFC data transfer between the communications interface 330 of the contactless payment card 318 and the card reader 316 of the mobile device 302. In some embodiments, a user application, such as 132 of FIG. 1, executing on the mobile device 302 may trigger the card reader 316 via an application program interface (API) call. In one example, the mobile device 302 triggers the card reader via an API call responsive to the user tapping or otherwise selecting an element of the user interface. In addition, or alternatively, the mobile device may trigger the card reader 316, for example, based on periodically polling the card reader 316. More generally, the mobile device 302 may trigger the card reader 316 to engage in communications using any feasible method. After communication has been established between mobile device and contactless card 318, the applet 322 executing on a processor (not shown in this example) of the contactless card 318 generates and transmits data to the mobile device via the communications interface 330. In some embodiments, the data generated by the contactless card 318 may include an URL 328 and the encrypted data 326 to form the URL w/ Encrypted Data 344 (In the examples, the URL w/ Encrypted Data 344 may refer to both the URL and the encrypted data as a single element) that is transmitted via NFC from the contactless payment card 318 to the card reader 316 of the mobile device 302. The URL 328 that is included in the URL w/ Encrypted Data 344 may be directed to the authentication server 306. When the OS 310 of the mobile device 302 receives the URL 328 in the URL with encrypted data 344, the OS 310 may dynamically cause a browser application on the mobile device 302 to utilize the address contained in the URL 328 to communicate with the authentication server 306.

The URL 328 generated by the applet 322 may further include encrypted data 326, such as an encrypted authentication payload as parameters. As described in greater detail below, the encrypted authentication payload may be used by the authentication server 306 to validate the data generated by the contactless payment card 318. For example, the applet 322 of the contactless card 318 may use a cryptographic algorithm to generate a cryptographic payload of encrypted data 326 based at least in part on the private key 324 stored in the memory 320 of the contactless payment card 318. In such an embodiment, the private key 324 and some other piece of data (e.g., a customer identifier, account identifier, etc.) may be provided as the input to the cryptographic algorithm, which outputs the encrypted data 326. Generally, the applet 322 may use any type of cryptographic algorithm and/or system to generate the encrypted data 326, and the use of a specific cryptographic algorithm as an example herein should not be considered limiting of the disclosure. In some embodiments, the applet 322 may perform encryption using a key diversification technique to generate the cryptographic payload.

As stated, the applet 322 of the contactless card 318 may include the encrypted data 326 as a parameter of the URL 328, thereby generating a URL with encrypted data 344. For example, if the URL to the authentication server 306 is “http://www.example.com/authtapp” and the encrypted data 326 is “ABC123”, the URL with encrypted data 344 may be “http://www.example.com/authapp?data=ABC123,” where the encrypted data is represented by ABC123. In some embodiments, the applet 322 may encode the encrypted data 326 according to an encoding format compatible with URLs prior to including the encrypted data 326 as a parameter of the URL 328. For example, the encrypted data 326 may be a string of binary data (e.g., zeroes and ones), which may not be compatible with URLs. Therefore, the applet 322 may encode the encrypted data 326 to the American Standard Code for Information Interchange (ASCII) base64 encoding format. Doing so represents the binary encrypted data 326 in an ASCII string format by translating it into a radix-64 representation (e.g., “ABC123” in the previous example).

Once generated, the applet 322 may transmit the URL 328 with encrypted data 326 to the mobile device 302 e.g., via NFC. In one example, when received by the OS 310, the OS 310 or user application 132 causes the web browser 312 to access the URL 328 with encrypted data 326. Doing so causes information describing the mobile device 302 to be sent with encrypted data 344 in the authentication request to access the URL, which directs the mobile device 302 to communication with the authentication server 306. For example, the information may include attributes of the mobile device, such as a mobile device identifier, operating system version, hardware capabilities, and software capabilities. An example of the mobile device identifier may be the mobile device IMEI or cellular number or the like. In response, the authentication server 306 may be operable to decode the encrypted data 344 and locate information based on the mobile device identifier, transmitting the decoded encrypted data 344 to the authentication server 306.

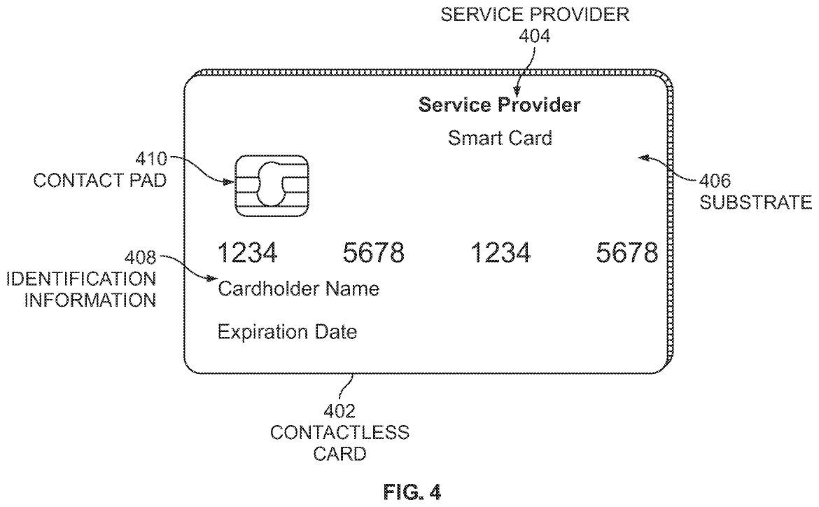

FIG. 4 illustrates an example of a contactless card usable in the examples described herein.

The system comprises a contactless card 402, a service provider 404, a substrate 406, an identification information 408, and a contact pad 410. FIG. 4 illustrates contactless card 402, which may be a contactless payment card, such as a credit card, debit card, and/or an identification card that may act as a credential apparatus. The contactless card 402 may also be referred to interchangeably herein as a credential apparatus, a contactless payment card, or an authentication apparatus. Other examples of an authentication apparatus may be a key fob, a pendant, a bracelet, a smart wearable device (e.g., a fitness device or a smartwatch) or the like. As shown, the contactless card 402 may be issued by a service provider 404 displayed on the front or back of the contactless card 402. In some examples, the contactless card 402 is not related to a payment card, and may comprise, without limitation, an identification card or an insurance card. In some examples, the contactless card 402 may be a dual interface contactless card. For example, the contactless card 402 may include a substrate 406, which may have a single layer, or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 402 may have physical characteristics compliant with the ID-1 format of the ISO/IEC 7610 standard, and the contactless card 402 may otherwise be compliant with the ISO/IEC 14443 standard. However, it is understood that the contactless card 402 according to the present disclosure may have different characteristics and that the contactless card may be implemented as a card or device other than a payment card.

The contactless card 402 may also include identification information 408 displayed on the front and/or back of the card, and a contact pad 410. The contact pad 410 may be configured to establish contact with another communication device, such as a mobile device, a user device, smart phone, laptop, desktop, or tablet computer. The contactless card 402 may also include processing circuitry, antenna and other components not shown in FIG. 4. These components may be located behind the contact pad 410 or elsewhere on the substrate 406. The contactless card 402 may also include a magnetic strip or tape, which may be located on the back of the card (not shown in FIG. 4).

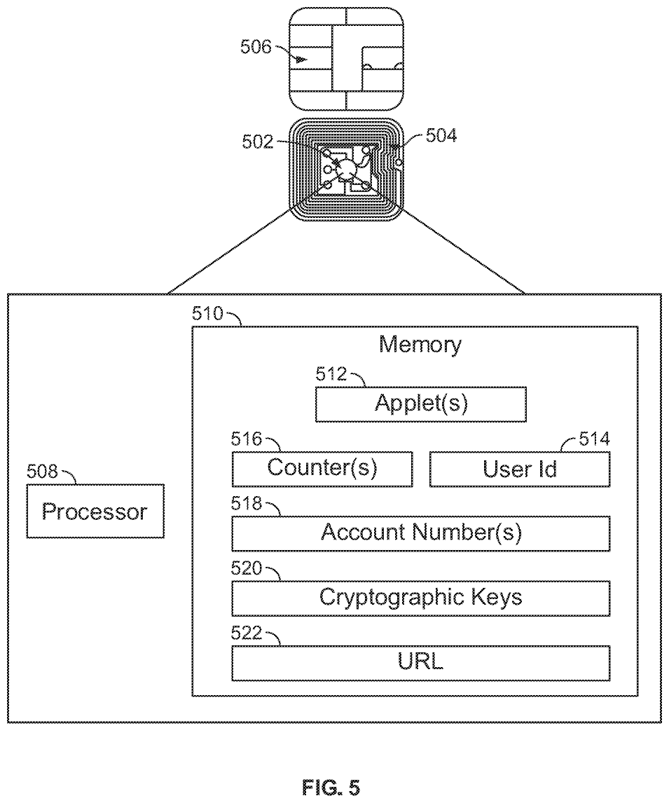

FIG. 5 illustrates additional features of the example contactless card of FIG. 4.

As illustrated in FIG. 5, an example of a contact pad 506 useable with the contactless card 402 of FIG. 4 may include processing circuitry 502 for storing and processing information, including a microprocessor 508 and the memory 510. It is understood that the processing circuitry 502 may contain additional components, including processors, memories, error and parity/CRC checkers, data encoders, anti-collision algorithms, controllers, command decoders, security primitives and tamper-proofing hardware, that may be operable to perform the functions described herein.

For example, the memory 510 may be a read-only memory, write-once read-multiple memory or read/write memory, e.g., RAM, ROM, and EEPROM, and the contactless card 402 of FIG. 4 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory.

The memory 510 may be configured to store one or more applets 512, one or more counters 516, a customer identifier (Id) 514, and the virtual account numbers 518. The one or more applet(s) 512 may comprise one or more software applications configured to execute on one or more contactless cards, such as a Java® Card applet. However, it is understood that applet(s) 512 are not limited to Java Card applets, and instead may be any software application operable on contactless cards or other devices having limited memory and processing capabilities. The one or more counters 516 may, for example, include a numeric counter sufficient to store an integer. The customer id 514 may, for example, include a unique alphanumeric identifier assigned to a user of the contactless card 402, and the customer id 514 may distinguish the user of the contactless card from other contactless card users. In some examples, the customer identifier 514 may identify both a user and an account assigned to that user at an entity, such as a financial institution, and may further identify the contactless card associated with the user's account. Or the user id 514 may identify the user and a mobile device associated with that user. Or the user id 514 may identify the user, an account assigned to that user at an entity, and a mobile device associated with that user. In some examples, the account number(s) 518 may include tens, hundreds or thousands of one-time use virtual account numbers associated with the contactless card 402. Another applet of the applet(s) 512 may be configured to manage the account numbers 518.

The processor and memory elements of the foregoing exemplary examples are described with reference to the contact pad, but the present disclosure is not limited thereto. It is understood that these elements may be implemented outside of the contact pad 506 or entirely separate from it, or as further elements in addition to microprocessor 508 and memory 510 elements located within the contact pad 506.

In some examples, the contact pad 506 may include one or more antennas 504. Alternatively, the one or more antennas 504 may be placed within the contactless card 402, such as around the processing circuitry 502 of the contact pad 506. For example, the one or more antennas 504 may be integral with the processing circuitry 502 and the one or more antennas 504 may be used with an external booster coil. As another example, the one or more antennas 504 may be external to the contact pad 420 and the processing circuitry 502. More generally, using the antennas 504, processing circuitry 502, and/or the memory 510, the contact pad 506 provides a communications interface to communicate via NFC, Bluetooth, and/or Wi-Fi communications as described with reference to the examples of FIGS. 1-4.

As explained above, contactless cards contactless card 402 may be built on a software platform operable on smart cards or other devices having limited memory, such as JavaCard, and one or more or more applications or applets may be securely executed. Applet(s) 512 may be configured to respond to one or more requests, such as near field data exchange (NDEF) requests, from a reader, such as a mobile NFC reader (e.g., of the mobile device 102 or 328), and produce, for example, an NDEF message that comprises a cryptographically secure encrypted information encoded as an NDEF text tag.

In some examples, the contactless card 402 and/or mobile device (e.g., 102 or 328) may include certain data such that the contactless card 402 and the user may be properly identified and authenticating information obtained for processing. The contactless card 402 may comprise one or more unique identifiers (not shown). Each time a read operation takes place, the counters 516 may be configured to increment. In some examples, each time data from the contactless card 402 is read (e.g., by a mobile device 102 or 328), the counter 516, as one of a number of multiple parameters, may be used by the authentication server 116 and/or the authentication app 306 or the authentication app 704 to authenticate other parameters of the multiple parameters. For example, the counter 516 value may be compared to a trusted counter value (e.g., maintained in a secure element or by an authentication server 116) determined to be equal and therefore, the other parameters (e.g., user may be considered authentic). Other examples of a parameter of the multiple parameters in the encrypted authentication payload may include, for example, a version number, a unique identifier of the user, an application transaction counter, a one-time password, or a cryptogram usable to validate message integrity.

In an example, the one or more counters 516 may be configured to prevent a replay attack. For example, if a cryptogram has been obtained and replayed, that cryptogram is immediately rejected if the counter 516 has been read, used or otherwise passed over. If the counter 516 has not been used, it may be replayed. In some examples, the counter that is incremented on the card is different from the counter that is incremented for transactions. In some examples, the contactless card 402 is unable to determine the application transaction counter 516 since there is no communication between applets 512 on the contactless card contactless card 402. In some examples, the contactless card 402 may include multiple applets 512, such as a first applet, which may be a transaction applet, and a second applet that monitors a number of times or when the counter 516 is read.

For example, in response to contactless card 402 being engaged to communicate with a mobile device, whether it is user mobile device 102 or mobile device 302, the contactless card 402 may be operable to generate encrypted information. The encrypted information delivered to the mobile device, such as user mobile device 102 or mobile device 302 may include a reference link, such as URL 522. Once the user taps the contactless card 402 to the mobile device, the URL 522 delivered via the contact pad 506 may be provided to an authentication application, a user application 132, or the like executing on the mobile device. As shown, the URL 522 may be stored in the memory 510 and/or may be generated by the applet 512.

In a specific example, the URL 522 may be directed to the authentication app 306 or the authentication server 116 of FIG. 1. The URL 522 may further include data (e.g., parameters) used by the authentication server 116 to validate the data generated by the contactless card contactless card 402. For example, the applet(s) 512 of the contactless card 402 may include the multiple parameters of the encrypted information as a parameter of the URL. The authentication app 304, the authentication server 116, or both may attempt to decrypt the encrypted information using a private key associated with the contactless card 402 of an account associated with the user or the user's mobile device.

For example, the encrypted information may be a string of characters, such as “ABC123”. The applet(s) 512 may include the generated encrypted information as a parameter of the URL 522, thereby generating a URL with encrypted information. For example, the URL 522 to the authentication server 116 may be “http://www.example.com/”. Therefore, the URL 522 with encrypted information, such as URL w/ Encrypted Data 344 of FIG. 3, may be “http://www.example.com/? ABC123”. In some embodiments, the applet(s) 512 may encode the encrypted information according to an encoding format compatible with URLs prior to including the encrypted information as a parameter of the URL 522. For example, the encrypted information may be a string of binary data (e.g., zeroes and ones), which may not be compatible with URLs. Therefore, the applet 103 may encode the encrypted information to the American Standard Code for Information Interchange (ASCII) base64 encoding format. Doing so represents the binary encrypted information in an ASCII string format by translating it into a radix-64 representation (e.g., “ABC123” in the previous example).

Once generated, the applet(s) 512 may transmit the URL 522 with encrypted information to the user mobile device 102 or mobile device 302, e.g., via NFC. In one embodiment, when received by the user mobile device 102 or a mobile device 302, an application, such as the user application 132 may open to access the URL 522 with encrypted information and transmit the encrypted information to an authentication server, such as authentication system 124 of FIG. 1, for example, that is addressed by the URL 522.

A key diversification technique described herein with reference to the counter 516 that may utilize cryptographic keys 520 (e.g., a master key and a diversified key) is an example of a key diversification technique. This example key diversification technique should not be considered limiting of the disclosure, as the disclosure is equally applicable to other types of key diversification techniques.

For example, during the creation process of the contactless card contactless card 402, two cryptographic keys 520 may be assigned uniquely per card. The cryptographic keys 520 may include symmetric keys, which may be used in both encryption and decryption of data. In an example, triple data encryption algorithm (3DES) may be used by a payment method such as Europay, Mastercard and Visa (EMV) and may be implemented by hardware in the contactless card 402. By using the key diversification process, one or more keys may be derived from a master key based upon uniquely identifiable information for each entity that requires a cryptographic key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 402 is used in operation, a different key may be used for creating a tag, such a message authentication code (MAC), and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

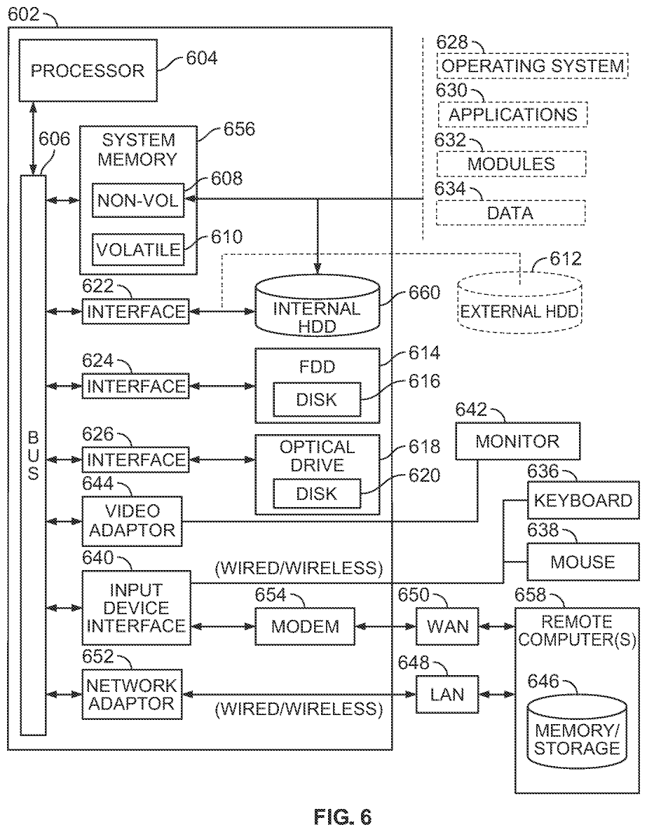

FIG. 6 illustrates an example of an exemplary computing architecture 602 that may be suitable for implementing various examples as previously described. In various examples, the computing architecture 602 may include or be implemented as part of an electronic device. In some examples, the computing architecture 602 may be representative, for example, of the user mobile device 102, of servers implementing or computers providing the website 108 or mobile website 104, the third-party authentication system 130, and the authentication system 124 of the system 100. The examples are not limited in this context. More generally, the computing architecture 602 may be operable to implement all logic, applications, systems, methods, apparatuses, and functionality described herein with reference to the examples of FIGS. 1-5.

The computing architecture 602 may include various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The examples, however, are not limited to implementation by the computing architecture 602.

As shown in FIG. 6, the computing architecture 602 comprises a processor 604, a system memory system bus 606 and a system bus 608. The processor 604 can be any of various commercially available computer processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi-processor architectures may also be employed as the processor 604.

The system bus 606 provides an interface for system components including, but not limited to, the system memory 656 to the processor 604. The system bus 606 can be any of several types of bus structure that may further interconnect to a memory bus (with or without a memory controller), a peripheral bus, and a local bus using any of a variety of commercially available bus architectures. Interface adapters may connect to the system bus 606 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (PCI), PCI Extended (PCI(X)), PCI Express, Personal Computer Memory Card International Association (PCMCIA), and the like.

The system memory 656 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated example shown in FIG. 6, the system memory 656 can include non-volatile memory (non-vol) 608 and/or volatile memory 610. A basic input/output system (BIOS) can be stored in the non-volatile memory 612.

The computing architecture 602 may include various types of computer-readable storage media in the form of one or more lower speed memory units, including an internal hard disk drive (HDD) 660, a magnetic floppy disk drive (FDD) 614 to read from or write to a removable magnetic disk 616, and an optical disk drive 618 to read from or write to a removable optical disk 620 (e.g., a CD-ROM or DVD). The HDD 660 or 612, the FDD 614 and optical disk drive 618 can be connected to the system bus 606 by an HDD interface 622, an FDD interface 624 and an optical drive interface 626, respectively. The HDD interface 622 for external drive implementations can include at least one or both of Universal Serial Bus (USB) and IEEE 1394 interface technologies. The computing architecture 602 is generally is configured to implement all logic, systems, methods, apparatuses, and functionality described herein with reference to FIGS. 1-5.

The drives and associated computer-readable media provide volatile and/or nonvolatile storage of data, data structures, computer-executable instructions, and so forth. For example, a number of program modules can be stored in the drives and memory units 608, 610, including an operating system 628, one or more application programs (or “applications”) 630, other program modules 632, and program data 634. In one example, the one or more applications 630, other program modules 632, and program data 634 can include, for example, the various applications and/or components of the system 100, e.g., the user application 132, or the like.

A user, for example, can enter commands and information into the computing architecture 602 through one or more wire/wireless input devices, for example, a keyboard 636 and a pointing device, such as a mouse 638. Other input devices may include microphones, infra-red (IR) remote controls, radio-frequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, trackpads, sensors, styluses, and the like. These and other input devices are often connected to the processor 604 through an input device interface 640 that is coupled to the system bus 606 but can be connected by other interfaces such as a parallel port, IEEE 1394 serial port, a game port, a USB port, an IR interface, and so forth.

A monitor 642 or other type of display device is also connected to the system bus 606 via an interface, such as a video adaptor 644. The monitor 642 may be internal or external to the computing architecture 602. In addition to the monitor 642, a computer typically includes other peripheral output devices, such as speakers, printers, and so forth.

The computing architecture 602 may operate in a networked environment using logical connections via wire and/or wireless communications to one or more remote computers, such as a remote computer 658. The remote computer 658 can be a workstation, a server computer, a router, a personal computer, portable computer, microprocessor-based entertainment appliance, a peer device or other common network node, and typically includes many or all of the elements described relative to the computing architecture 602, although, for purposes of brevity, only a memory/storage device 646 is illustrated. The logical connections depicted include wire/wireless connectivity to a local area network (LAN) 648 and/or larger networks, for example, a wide area network (WAN) 650. Such LAN and WAN networking environments are commonplace in offices and companies, and facilitate enterprise-wide computer networks, such as intranets, all of which may connect to a global communications network, for example, the Internet. In examples, the data network 106 of FIG. 1 may be one or more of the LAN 648 and the WAN 650.

When used in a LAN networking environment, the computing architecture 602 is connected to the LAN 648 through a wire and/or wireless communication network interface or network adaptor 652. The network adaptor 652 can facilitate wire and/or wireless communications to the LAN 648, which may also include a wireless access point disposed thereon for communicating with the wireless functionality of the network adaptor 652.

When used in a WAN networking environment, the computing architecture 602 can include a modem 654, or is connected to a communications server on the WAN 650 or has other means for establishing communications over the WAN 650, such as by way of the Internet. The modem 654, which can be internal or external and a wire and/or wireless device, connects to the system bus 608 via the input device interface 640. In a networked environment, program modules depicted relative to the computing architecture 602, or portions thereof, can be stored in the remote memory/storage device 646. It will be appreciated that the network connections shown are exemplary and other means of establishing a communications link between the computers can be used.

The computing architecture 602 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

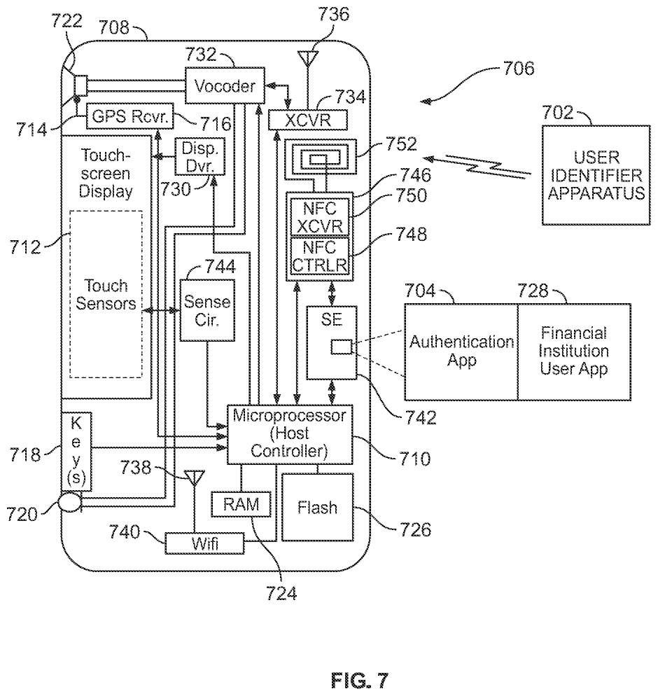

FIG. 7 illustrates an example of a system including a mobile device usable for implementing the techniques and processes discussed with reference to the examples of FIGS. 1-5. The illustrated system 700 may include a mobile device 706 and a user identifier apparatus 702.

The mobile device 706 may be a smart phone including a display device, such as a touch screen display 708. The touch screen display 708 may be coupled to the microprocessor 710 and be operable to present screen content and receive inputs via touch sensors 712. The inputs to the touch sensors 712 may be processed by the sense circuitry 744. Examples of touch screen type mobile devices, such as mobile device 706, may include (but are not limited to) a smart phone, personal digital assistant (PDA), tablet computer, smart watch, or another portable device. However, the structure and operation of mobile device 706 that utilizes a touch screen is provided by way of example; and the subject technology as described herein is not intended to be limited thereto. The logic implemented by the microprocessor 710 of the mobile device 706 configures the microprocessor 710 to control various functions as implemented by the mobile device 706. The logic for a processor may be implemented in a variety of ways, but in the presented examples, the processor logic is implemented by programming for execution by the microprocessor 710.

There are a variety of ways that a mobile device 706 may be operable to obtain information as to current location of the device. In our example, the mobile device 706 includes a global positioning satellite (GPS) receiver 716 and associated antenna 714. GPS is a space-based satellite navigation system that provides location and time information practically anywhere on Earth. A rechargeable battery (not shown) may provide electrical power sufficient to power the various components of the mobile device 706.

The mobile device 706 further includes a microprocessor 710, which serves as a programmable controller for mobile device 706 by configuring the mobile device to perform various operations, for example, in accordance with instructions or programming executable by microprocessor 710. For example, such operations may include various general operations of the mobile device 706 as well as operations related to the user authentication functions as described herein. A flash memory 726 may be used to store, for example, programming or instructions for execution by the microprocessor 710. Depending on the type of device, the mobile device 706 stores and runs an operating system through which specific applications may be run on the device. Examples of operating systems include Android, Apple iOS, Microsoft Windows OS, Bada, Tizen, Symbian OS, Blackberry OS, or the like. The flash memory 726 may also be used to store mobile configuration settings for different mobile applications or services executable at mobile device 706 (using microprocessor 710). The mobile device 706 may also include a non-volatile random-access memory (RAM) 724 for a working data processing memory. The RAM 724, flash memory 726, and secure element storage 742 may be coupled to the microprocessor 710 and operable to store programming code executable by the microprocessor 710.

A mobile device supporting the claim processing and authentication techniques described herein may include a variety of different types of user interface elements. For discussion purposes, in the smart phone example of a mobile device shown in FIG. 7, the user interface elements of mobile device 706 may include the touch screen display 708. For output purposes, the touch screen display 708 may include a display screen, such as a liquid crystal display (LCD) or the like. For input purposes, touch screen display 708 includes a plurality of touch sensors 712 that output signals processed by sense circuitry 744. Other interface elements may include a keypad including one or more keys 718. For example, the keypad may be implemented in hardware as a T9 or QWERTY keyboard of mobile device 706 and keys 718 may correspond to the physical keys of such a keyboard. Alternatively, keys 718 (and keyboard) of mobile device 706 may be implemented as “soft keys” of a virtual keyboard graphically represented in an appropriate arrangement via touch screen display 708. The soft keys presented on the touch screen display 708 may allow the user of mobile device 706 to invoke the same user interface functions as with the physical hardware keys. In some implementations, the microphone 720 and speaker 722 may be used as additional user interface elements, for audio input and output, including with respect to some functions related to the processing related to engaging with the authentication app 704, as described herein. In a further example, the authentication app 704 may in response to accessing contacts stored in the RAM 724, present in the user interface a prompt to a user to interact the mobile device 706 with a user identifier apparatus 702, such as contactless card 110 to obtain the encrypted information, an encrypted authentication payload or a URL with encrypted data, such as URL w/ Encrypted Data 344, for processing by the user app 728 or authentication app 704 or for transmission by a browser, such as a web browser 312.

For output, touch screen display 708 is a display device used to present information (e.g., text, video, graphics or other visible content) to the user of mobile device 706. Microprocessor 710 controls visible display output on the LCD or other display element of the touch screen display 708 via a display driver 730, to present the various visible outputs to the device user.

The microphone 720 and speaker 722 are communicatively coupled to a voice or audio encoder/decoder (vocoder) 732. For a voice telephone call, for example, the vocoder 732 provides two-way conversion between analog audio signals representing speech or other audio and digital samples at a compressed bit rate compatible with the digital protocol of wireless telephone network communications or voice over packet (e.g., Internet Protocol) communications. The vocoder, speaker and microphone may also be used as elements of the user interface during other operations of the device, including some types of transaction communications.

Also, as shown in FIG. 7, the mobile device 706 includes at least one transceiver 734 (labeled XCVR in figure) and an associated antenna 736, which may be a digital transceiver for digital wireless communications via a wide area wireless mobile communication network, although the mobile device 706 may include additional digital or analog transceivers (not shown). The transceiver 734 conforms to one or more of the various digital wireless communication standards utilized by modern mobile networks. Examples of such transceivers include (but are not limited to) transceivers operable to operate in accordance with Code Division Multiple Access (CDMA) and 3rd Generation Partnership Project (3GPP) network technologies including, for example and without limitation, 3GPP type 2 (or 3GPP2) and 3GPP Long Term Evolution (LTE) (or “4G”), fifth generation wireless (5G). For example, the transceiver 734 may provide two-way wireless communication of information including digitized audio signals, still image and/or video signals, web page information for display as well as web related inputs, and various types of mobile message communications to/from the mobile device 706. The transceiver 734 may also support various types of mobile messaging services, such as short message service (SMS), enhanced messaging service (EMS), and/or multimedia messaging service (MMS).

In an example, the transceiver 734 may be coupled to the microprocessor 710 and operable to exchange communications. The microprocessor 710 of the mobile device 706 may be further operable to perform additional functions, including functions to establish, using the transceiver, a connection with a server or entity, such as the authentication server 116 and website 108 of FIG. 1, to exchange communications. Via the connection with the server or website, the mobile device 706 may be able to obtain various information, such as authentication information, product information, user information, and the like. The processor upon execution of the authentication app 704 and the user app 728 may implement the examples as discussed above with reference to FIGS. 1-5.

The mobile device 706 may also include a Wi-Fi transceiver 740 and associated Wi-fi antenna 738. Although Wi-Fi is used here as the example, the transceiver 740 may take the form of any available two-way wireless local area network transceiver of a type that is compatible with one or more standard protocols of communication implemented in wireless local area networks, such as one of the Wi-Fi standards under IEEE 702.11 and/or WiMAX.

Alternatively, or in addition, applications may be stored in secure element (SE) storage 742, which may be a solid-state memory storage or other memory device suitable for storing applications. In one example, the secure element storage 742 may be a separate chip that includes tamperproof storage and execution memory and is operable to communicate with operating system. The secure element storage 742 may, for example, store an instance of an authentication app 704 for processing receipt data, communicating with one or more services or servers, and processes as described with reference to the examples of FIGS. 1-3. Other applications such as authentication app 704 and user app 728 may also be stored in secure element storage 742.

The mobile device 706 may also include a near-field communication device 746 that is coupled to the secure element storage 742 and the microprocessor 710. As discussed in the earlier examples, the authentication app 704 and the user app 728, when executed by the microprocessor 710, may be operable to control the near-field communication device 746 and receive signals from the user identifier apparatus 702, which may be implemented as the contactless card 110, the credential apparatus 330, or the contactless card 402. Details of the user identifier apparatus 702 may be obtained from the earlier discussion of the contactless card 110, the credential apparatus 330, or the contactless card 402. As explained above, the contactless card 402 when implemented as the user identifier apparatus 702, may be built on a software platform operable on smart cards or other devices having limited memory, such as JavaCard, and one or more applications or applets may be securely executed. Applets may, for example, be added to contactless cards to provide, as mentioned above, authentication in various mobile application-based use cases, such as the above described user authentication for transaction completion examples. Applets may be configured to respond to one or more requests, such as near field data exchange requests, from an application, such as authentication app 704 or user app 728, such that the mobile NFC reader (e.g., the near-field communication device 746 of the mobile device 706), is operable to receive or produce an NDEF message that comprises a cryptographically secure payload encoded as an NDEF message.

In the example, the near-field communication device 746 may include an NFC controller 748, NFC transceiver 750 and an NFC antenna 752. The NFC controller 748 may initiate contact with the user identifier apparatus 702 according to known NFC communication protocols and cause the NFC transceiver 750 to transmit signals and receive signals via the NFC antenna 752 to establish communications with the user identifier apparatus 702. The user app 728 may process the signals received from the user identifier apparatus 702 as described above with reference to the examples of FIGS. 1-5. As described in the example of FIGS. 1-3, the authentication app 704 may process the received signals.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

As used in this application, the terms “system” and “component” and “module” are intended to refer to a computer-related entity, either hardware, a combination of hardware and software, software, or software in execution, examples of which are provided by the exemplary computing architecture 800. For example, a component can be, but is not limited to being, a process running on a computer processor, a computer processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further examples, however, may alternatively employ data messages. Such data messages may be sent across various connections. Exemplary connections include parallel interfaces, serial interfaces, and bus interfaces.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more features as variously disclosed or otherwise demonstrated herein.

What is claimed is:

1. A method, comprising:
receiving, at a financial institution system of a financial institution from a website, a notification that a financial transaction authentication request from a user will be received at the financial institution system within a predetermined time period of receipt of the notification, wherein the notification includes a verification identifier of the user that was input during a transaction session with the website;
causing a prompt to be presented on a mobile device corresponding to the verification identifier of the user, wherein the presented prompt includes a request for confirmation of a pending transaction via a near-field communication interaction with a contactless card associated with the financial institution;
receiving, in response to a near-field communication interaction responsive to presentation of the presented prompt, a financial transaction authentication request including an encrypted authentication payload at an authentication web address of the financial institution system as the confirmation of the pending transaction, wherein a portion of the encrypted authentication payload is maintained on the contactless card;
decrypting the encrypted authentication payload;
obtaining multiple parameters from the decrypted authentication payload;
authenticating, by using one or more of the multiple parameters, the user as a holder of the contactless card; and
in response to authenticating the user as the holder of the contactless card, enabling completion of the pending transaction by sending user identifying information to the website.

2. The method of claim 1, further comprising:
after expiration of the predetermined time period, receiving a hyperlink corresponding to the transaction session which was deactivated by the website after the expiration of the predetermined time period;
maintaining, temporarily, the hyperlink in a data storage in association with information related to the user; and
in response to a further notification from the website regarding the user, using the hyperlink to reactivating the transaction session at the website.

3. The method of claim 1, wherein generating the prompt for presentation on the mobile device corresponding to the verification identifier of the user, comprises:
populating a message with instructions executable by the mobile device that causes the mobile device to initiate a near-field communication read of the contactless card and with a hyperlink to the authentication web address of the financial institution; and
forwarding the message to the mobile device corresponding to the verification identifier of the user, wherein the message may be formatted as a short message service message, a multimedia messaging service message, or as a financial institution in-application notification.

4. The method of claim 1, wherein causing the presented prompt to be presented, further comprises:
forwarding a message to the mobile device to present the presented prompt, and
initiate a background read of the contactless card by a near-field communication device of the mobile device.

5. The method of claim 1, wherein decrypting the encrypted authentication payload further comprises:
applying a decryption algorithm to the encrypted authentication payload to obtain the multiple parameters from the authentication payload usable to authenticate the user.

6. The method of claim 5, wherein the multiple parameters in the encrypted authentication payload include a version number, a unique identifier of the user, an application transaction counter, a one-time password, or a cryptogram usable to validate message integrity.

7. The method of claim 1, wherein when authenticating the user as a holder of the contactless card using the one or more of the multiple parameters further comprises:
using one or more of the multiple parameters that include a version number, a unique identifier of the user, an application transaction counter, a one-time password, or a cryptogram usable to validate message integrity, confirm that information related to the user provided by the website is substantially identical to information of the user maintained by the financial institution system.

8. A non-transitory computer-readable storage medium, the computer-readable storage medium including instructions that when executed by a processor, cause the processor to:
receive, at a financial institution system from a website, a notification that a financial transaction authentication request from a user will be received at the financial institution system within a predetermined time period of receipt of the notification, wherein the notification includes a verification identifier of the user that was input during a transaction session with the website;
cause a prompt to be presented on a mobile device corresponding to the verification identifier of the user, wherein the presented prompt includes a request for confirmation of a pending transaction via a near-field communication interaction with a contactless card associated with the user and the financial institution system;
receive, in response to a near-field communication interaction responsive to presentation of the presented prompt, a financial transaction authentication request including an encrypted authentication payload at an authentication web address of the financial institution system as the confirmation of the pending transaction, wherein a portion of the encrypted authentication payload is maintained on the contactless card;
decrypting the encrypted authentication payload;
obtain multiple parameters from the decrypted authentication payload;
authenticate the user as a holder of the contactless card using one or more of the multiple parameters; and
in response to authenticating the user as a holder of the contactless card, enable completion of the pending transaction by sending user identifying information to the website.

9. The computer-readable storage medium of claim 8, wherein the instructions further cause the processor to:
after expiration of the predetermined time period, receive a hyperlink corresponding to the transaction session which was deactivated by the website after the expiration of the predetermined time period;
maintain, temporarily, the hyperlink in a data storage in association with information related to the user; and
in response to a further notification from the website regarding the user, using the hyperlink to reactivating the transaction session at the website.

10. The computer-readable storage medium of claim 8, wherein when generating the prompt for presentation on the mobile device corresponding to the verification identifier of the user, the instructions further cause the processor to:
populate a message with instructions executable by the mobile device that causes the mobile device to initiate a near-field communication read of the contactless card and with a hyperlink to the authentication web address of the financial institution system; and
forward the message to the mobile device corresponding to the verification identifier of the user, wherein the message may be formatted as a short message service message, a multimedia messaging service message, or as a financial institution in-application notification.

11. The computer-readable storage medium of claim 8, wherein the instructions further cause the processor to:
forward instructions to the mobile device operable initiate a background read of the contactless card by a near-field communication device of the mobile device.

12. The computer-readable storage medium of claim 8, wherein when decrypting the encrypted authentication payload, the instructions further cause the processor to:
apply a decryption algorithm to the encrypted authentication payload to obtain the multiple parameters from the authentication payload usable to authenticate the user.

13. The computer-readable storage medium of claim 12, wherein when decrypting the encrypted authentication payload, the instructions further cause the processor to:
obtain a version number, a unique identifier of the user, an application transaction counter, a one-time password, or a cryptogram usable to validate message integrity as the multiple parameters in the encrypted authentication payload.

14. The computer-readable storage medium of claim 8, wherein when authenticating the user as a holder of the contactless card using the one or more of the multiple parameters, the instructions further cause the processor to:
confirm, by using one or more of the multiple parameters that include a version number, a unique identifier of the user, an application transaction counter, a one-time password, or a cryptogram usable to validate message integrity, that information related to the user provided by the website is substantially identical to information of the user maintained by the financial institution system.

15. A computing apparatus comprising:
a processor circuit; and
a memory storing instructions that, when executed by the processor, the computing apparatus is operable to:
receive a notification that a financial transaction authentication request from a user will be received within a predetermined time period of receipt of the notification, wherein the notification includes a verification identifier of the user that was input during a transaction session with a website for a pending transaction;
generate for presentation on a mobile device corresponding to the verification identifier of the user, a prompt that includes a request for confirmation of a pending transaction via a near-field communication interaction with a contactless card associated with a financial institution system;
receive, in response to a near-field communication interaction responsive to presentation of the presented prompt, a financial transaction authentication request including an encrypted authentication payload at an authentication web address of the financial institution system as the confirmation of the pending transaction, wherein a portion of the encrypted authentication payload is maintained on the contactless card;
decrypting the encrypted authentication payload;
obtain multiple parameters from the decrypted authentication payload;
authenticate the user as a holder of the contactless card using one or more of the multiple parameters; and
in response to authenticating the user as a holder of the contactless card, enable completion of the pending transaction by sending user identifying information to the website.

16. The computing apparatus of claim 15, wherein the instructions further configure the computing apparatus to:
after expiration of the predetermined time period, receive a hyperlink corresponding to the transaction session which was deactivated by the website after the expiration of the predetermined time period;
maintain, temporarily, the hyperlink in a data storage in association with information related to the user; and
in response to a further notification from the website regarding the user, using the hyperlink to reactivating the transaction session at the website.

17. The computing apparatus of claim 15, wherein generating the prompt for presentation on the mobile device corresponding to the verification identifier of the user, comprises:
populate a message with instructions executable by the mobile device that causes the mobile device to initiate a near-field communication read of the contactless card and with a hyperlink to the authentication web address of the financial institution; and
forward the message to the mobile device corresponding to the verification identifier of the user, wherein the message may be formatted as a short message service message, a multimedia messaging service message, or as a financial institution in-application notification.

18. The computing apparatus of claim 15, wherein the instructions further configure the computing apparatus to:
forward instructions to the mobile device to initiate a background read of the contactless card by a near-field communication device of the mobile device.

19. The computing apparatus of claim 15, wherein decrypting the encrypted authentication payload further comprises:
apply a decryption algorithm to the encrypted authentication payload to obtain the multiple parameters from the authentication payload usable to authenticate the user.

20. The computing apparatus of claim 19, wherein the multiple parameters in the encrypted authentication payload include a version number, a unique identifier of the user, an application transaction counter, a one-time password, or a cryptogram usable to validate message integrity.
